(19) United States
(12) Patent Application Publication
(10) Pub. No.: US 2024/0000091 A1
(43) Pub. Date: Jan. 4, 2024

(54) NUTRITIONAL SUPPLEMENT FOR LACTATING MOTHERS

(71) Applicant: THE BLOG EXPERTS LLC, Palm Beach Gardens, FL (US)

(72) Inventor: Katie Pickett, Palm Beach Gardens, FL (US)

(21) Appl. No.: 17/856,584

(22) Filed: Jul. 1, 2022

(51) Int. Cl. A23C 11/04; A23C 9/20; A23L 33/105; A23L 33/15; A23L 33/16; A23L 33/00; A23L 2/56

(52) U.S. Cl. CPC A23C 11/04; A23C 9/20; A23L 33/105; A23L 33/15; A23L 33/16; A23L 33/40; A23L 2/56

(57) ABSTRACT

A formulation including a nutritional supplement composition of matter in powder form for meeting the nutritional needs of lactating mothers, the composition including about 0.6 percent by weight of milk thistle powder, about 0.06 percent by weight of fenugreek powder, about 0.06 percent by weight of fennel seeds powder, about 1.98 percent by weight of red raspberry leaf powder, about 0.4 percent by weight of nutritional yeast, about 0.06 percent by weight of turmeric, about 0.003 percent by weight of chromium, about 0.05 percent by weight of zinc, about 0.7 percent by weight of magnesium, about 1.3 percent by weight of cinnamon bark powder, about 0.1 percent by weight of L-methylfolate, and about 0.009 percent by weight of vitamin B12.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed embodiments relate generally to nutritional and dietary supplements, and more specifically, to compositions that are customized for the nutritional needs of lactating mothers.

### BACKGROUND

Lactation describes the secretion of milk from the mammary glands and the period of time that a mother lactates to feed her young. The process naturally occurs with all sexually mature female mammals, and the process of feeding milk in all animals (including humans) is called nursing, and in humans it is also called breastfeeding. The chief function of a lactation is to provide nutrition and immune protection to the young after birth. Consequently, it is important that during the breastfeeding phase, mothers stay as healthy as possible for the sake of the child, as well as the mother's sake.

When a women is breastfeeding, her body needs an increase in calories and nutrients in order to maintain nutrient and energy stores while allowing for the gradual loss of weight gained during pregnancy. In most cases, the best way to get adequate calories and nutrients is to eat a healthy, well-balanced diet that includes fruits, vegetables, protein, grains, and a limited amount of fat, sometimes with a multivitamin supplement. But in certain cases, a lactating mother may not be getting adequate calories and nutrients. This can adversely affect the health of the mother, and therefore must be addressed to prevent adverse health effects.

It is also important to note that nutritional intake of the mother also affects milk content for some vitamins and minerals, such as vitamin A, thiamin, riboflavin, vitamin B6, vitamin B12, selenium, and iodine. If the mother does not get enough of these vitamins and minerals through diet alone, the mother may need to take supplements to ensure good milk quality and the good health of her child. If the mother eats a restricted diet (for example if the mother is vegetarian or vegan), then the mother must take specific supplements to account for any vitamins and minerals that may be missing from her diet.

One well known method of addressing the issue above is the use of dietary and nutritional supplements. A dietary or national supplement is a manufactured product intended to supplement one's diet by taking a pill, capsule, tablet, powder, or liquid. A supplement can provide nutrients either extracted from food sources or that are synthetic in order to increase the quantity of their consumption. The class of nutrient compounds includes vitamins, minerals, fiber, fatty acids, and amino acids. One of the problems associated with conventional dietary and nutritional supplements is that they are generally customized for certain functions, such as bodybuilding, weight gain, or weight loss. There are no available conventional dietary or nutritional supplements that address the needs of lactating mothers.

Therefore, a need exists to overcome the problems with the prior art as discussed above, and particularly for a more efficient way of providing lactating mothers with the proper nutritional and dietary supplements during the breastfeeding phase.

### SUMMARY

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

The disclosed embodiments are directed to a formulation comprising a nutritional supplement composition of matter in powder form, the composition comprising about 0.6 percent by weight of milk thistle powder, about 0.06 percent by weight of fenugreek powder, about 0.06 percent by weight of fennel seeds powder, about 1.98 percent by weight of red raspberry leaf powder, about 0.4 percent by weight of nutritional yeast, about 0.06 percent by weight of turmeric, about 0.003 percent by weight of chromium, about 0.05 percent by weight of zinc, about 0.7 percent by weight of magnesium, about 1.3 percent by weight of cinnamon bark powder, about 0.1 percent by weight of L-methylfolate, and about 0.009 percent by weight of vitamin B12.

In another embodiment, the formulation comprises a nutritional supplement composition of matter in powder form, the composition comprising about 18.5 percent by weight of pea protein powder, about 27.76 percent by weight of organic brown rice protein powder, about 12.78 percent by weight of organic pumpkin seed protein powder, about 0.22 percent by weight of organic blueberry powder, about 0.11 percent by weight of organic chia seed powder, about 0.57 percent by weight of chlorella, about 0.44 percent by weight of coconut milk powder, about 0.11 percent by weight of flaxseed powder, about 1.10 percent by weight of guar gum, about 0.06 percent by weight of monk fruit powder, about 0.22 percent by weight of raspberry ketones powder, about 1.98 percent by weight of spirulina powder, about 3.52 percent by weight of cinnamon powder, about 1.76 percent by weight of spinach powder, about 15.42 percent by weight of sugar powder, about 0.99 percent by weight of stevia powder, about 0.22 percent by weight of sweet enhancer powder, about 0.66 percent by weight of natural vanilla flavor, and about 0.66 percent by weight of xanthan gum.

To the accomplishment of the above and related objects, claimed subject matter may be embodied in the form illustrated in the accompanying drawings, attention being called to the fact, however, that the drawings are illustrative only, and that changes may be made in the specific construction illustrated and described within the scope of the appended claims. The foregoing and other features and advantages of the claimed embodiments will be apparent from the following more particular description of the preferred embodiments, as illustrated in the accompanying drawings.

### BRIEF DESCRIPTION OF THE DRAWINGS

The accompanying drawings, which are incorporated in and constitute part of this specification, illustrate embodiments of the claimed subject matter and together with the description, serve to explain the principles of the disclosed embodiments. The embodiments illustrated herein are presently preferred, it being understood, however, that the claimed subject matter is not limited to the precise arrangements and instrumentalities shown, wherein:

FIG. 1 is a perspective view of the molecular structure of silibinin;

FIG. 2 is a perspective view of the molecular structure of curcumin;

FIG. 3 is a perspective view of the molecular structure of magnesium citrate; and

FIG. 4 is a perspective view of the molecular structure of L-methylfolate.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting, reordering, or adding additional stages or components to the disclosed methods and devices. Accordingly, the following detailed description does not limit the disclosed embodiments. Instead, the proper scope of the disclosed embodiments is defined by the appended claims.

The claimed embodiments include a formulation for an article for human consumption, the article comprising a nutritional supplement composition of matter in powder form, the composition customized to the nutritional needs of lactating mothers. The preservatives added protect the formulation from microbial activity or growth. The claimed embodiments address the increase in calories and nutrients required by lactating mothers in order to maintain nutrient and energy stores while allowing for the gradual loss of weight gained during pregnancy. The claimed embodiments are particularly helpful in cases where a lactating mother may not be getting adequate calories and nutrients from their diet. The claimed embodiments can therefore positively affect the health of the mother and, by extension, her child.

The claimed embodiments also affect the milk content of the lactating mother by making sure the mothers gets enough of the vitamins and minerals required to ensure good milk quality and the good health of her child. The claimed embodiments also provide a simple, tasty and easy-to-consume nutritional supplement that is both good tasting, as well as nutritious. The claimed embodiments have a desirable aesthetic look and feel, while also exhibiting ease of consumption, and a uniform product that is stable.

Unlike other unstable products that separate into two or more phases or strata during its shelf life or at completion of packaging the product, the disclosed embodiments are homogenized and remain stable during their shelf life. Whereas other products may have precipitated particulate matter or ingredients that have been improperly incorporated, the disclosed embodiments are made uniform and smooth for an aesthetic look and feel. The disclosed embodiments are also designed for ease of consumption, which includes ease of dissolving the product in water, milk or the like. The aesthetic feel of the product is smooth and uniform and has a desirable feel during use.

The disclosed embodiments are directed to a formulation comprising a nutritional supplement composition of matter in powder form, the composition comprising about 0.6 percent by weight of milk thistle powder, about 0.06 percent by weight of fenugreek powder, about 0.06 percent by weight of fennel seeds powder, about 1.98 percent by weight of red raspberry leaf powder, about 0.4 percent by weight of nutritional yeast, about 0.06 percent by weight of turmeric, about 0.003 percent by weight of chromium, about 0.05 percent by weight of zinc, about 0.7 percent by weight of magnesium, about 1.3 percent by weight of cinnamon bark powder, about 0.1 percent by weight of L-methylfolate, and about 0.009 percent by weight of vitamin B12. The nutritional supplement composition of matter in powder form may be provided to consumers in a container, which may include a main compartment for holding the composition of mater, and a lid that is used to access the composition of matter.

In another embodiment, the formulation comprises a nutritional supplement composition of matter in powder form, the composition comprising about 18.5 percent by weight of pea protein powder, about 27.76 percent by weight of organic brown rice protein powder, about 12.78 percent by weight of organic pumpkin seed protein powder, about 0.22 percent by weight of organic blueberry powder, about 0.11 percent by weight of organic chia seed powder, about 0.57 percent by weight of chlorella, about 0.44 percent by weight of coconut milk powder, about 0.11 percent by weight of flaxseed powder, about 1.10 percent by weight of guar gum, about 0.06 percent by weight of monk fruit powder, about 0.22 percent by weight of raspberry ketones powder, about 1.98 percent by weight of spirulina powder, about 3.52 percent by weight of cinnamon powder, about 1.76 percent by weight of spinach powder, about 15.42 percent by weight of sugar powder, about 0.99 percent by weight of stevia powder, about 0.22 percent by weight of sweet enhancer powder, about 0.66 percent by weight of natural vanilla flavor, and about 0.66 percent by weight of xanthan gum.

The claimed embodiments may be stored and distributed in a container. Subsequently, the composition may be removed from the container and mixed with water, milk of the like by the consumer. The composition is structured to be consumed in small amounts at one time. A small amount is defined as an amount of powder that easily fits onto a scoop, spoon or the like by the consumer. A regimen may be used with the composition, such as consuming one unit of the composition periodically, such as once a day, every morning, or twice a day, for a defined period of time, such as during breastfeeding.

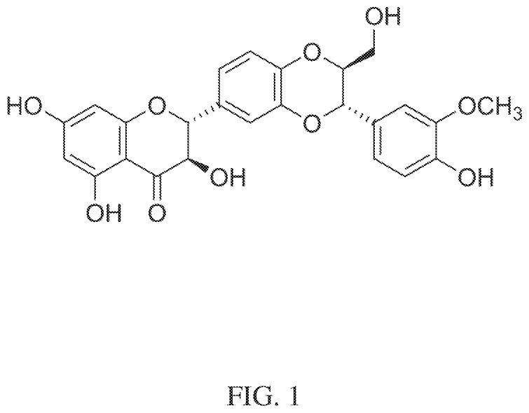

Milk thistle, also called silybum marianum, is a species of thistle. It has various common names including milk thistle, blessed milk thistle, Marian thistle, Mary thistle, Saint Mary's thistle, Mediterranean milk thistle, variegated thistle and Scotch thistle. This species is an annual or biennial plant of the family Asteraceae. This fairly typical thistle has red to purple flowers and shiny pale green leaves with white veins. Originally a native of Southern Europe through to Asia, it is now found throughout the world. Milk thistle has been used in traditional medicine for centuries, for the purpose of treating and preventing cancers. Silymarin is extracted from the milk thistle seeds and available as a standardized extract. Silymarin, also known as silibinin and as silybin, is the major active constituent of silymarin, a standardized extract of the milk thistle seeds, containing a mixture of flavonolignans consisting of silibinin, isosilibinin, silychristin, silidianin, and others. Silibinin itself is a mixture of two diastereomers, silybin A and silybin B (see FIG. 1), in approximately equimolar ratio. The mixture exhibits a number of pharmacological effects, particularly in the fatty liver, non-alcoholic fatty liver, non-alcoholic steatohepatitis, and there is great clinical evidence for the use of silibinin as a supportive element in alcoholic and Child-Pugh grade ‘A’ liver cirrhosis. Silibinin is available as drug in many EU countries and used in the treatment of toxic liver damage (e.g. IV treatment in case of death cap poisoning); as adjunctive therapy in chronic hepatitis and cirrhosis. Silibinin is under investigation to see whether it may have a role in cancer treatment (e.g. due to its inhibition of STAT3 signaling).

Silibinin also has a number of potential mechanisms that could benefit the skin. These include chemoprotective effects from environmental toxins, anti-inflammatory effects, protection from UV induced photocarcinogenesis, protection from sunburn, protection from UVB-induced epidermal hyperplasia, and DNA repair for UV induced DNA damage (double strand breaks). Studies on mice demonstrate a significant protection on chronic unpredictable mild stress (CUMS) induced depressive-like behavior on mice and increased cognition in aged rats as a result of consuming silymarin. Due to its immunomodulatory, iron chelating and antioxidant properties, this herb has the potential to be used in beta-thalassemia patients who receive regular blood transfusions and suffer from iron overload. Silibinin can be particularly helpful to lactating mothers due to the benefits described above.

Fenugreek also known as, trigonella foenum-graecum, is an herb similar to clover. The seed's taste resembles maple syrup and is used in foods and medicine. Fenugreek is native to the Mediterranean, Europe, and Asia. Fenugreek seems to slow sugar absorption in the stomach and stimulate insulin, which lowers blood sugar in people with diabetes. People commonly use fenugreek for diabetes, menstrual cramps, sexual problems, enlarged prostate, high cholesterol, obesity, and many other conditions. Fenugreek seed's ingredients include flavonoids, alkaloids, coumarins, vitamins, and saponins. The most prevalent alkaloid is trigonelline and coumarins include cinnamic acid and scopoletin. Based on the available evidence, fenugreek has benefits for lowering blood sugar levels, boosting testosterone, and increasing milk production in breastfeeding mothers.

Fennel, also known as foeniculum vulgare, is a flavorful culinary herb and medicinal plant. Besides its culinary uses, fennel and its seeds offer a wide array of health benefits and may provide antioxidant, anti-inflammatory, and antibacterial effects. The fennel plant has its origin in the southern Mediterranean region and through naturalization and cultivation it grows wild throughout the Northern, Eastern, and Western hemispheres, specifically in Asia, North America, and Europe. It is cultivated in fields and grows wild. Fennel and fennel seeds provide important nutrients, such as vitamin C, calcium, magnesium, potassium, and manganese. Fennel seeds are used around the world medicinally to treat everything from menstrual cramps to bad gas. One early study suggests that eating fennel seeds reduces appetite and significantly reduces overeating at mealtimes. This is especially helpful for people with obesity caused by food cravings and overeating. Anethole, one of the major compounds found in fennel seeds, has been shown to have cancer-fighting properties, research has shown its effectiveness at destroying breast cancer cells and stopping the spread of both breast and liver cancer cells. Fennel seeds contain estragole, fenchone and anethole, which contribute to the plant's antispasmodic and anti-inflammatory properties, which helps kick start digestion by promoting the production of gastric enzymes. Thanks to anethole, fennel seeds may also relax muscles in the intestines, which can help with constipation. Soothing muscles in the stomach and intestines helps to relieve gassiness that's from constipation or acid reflux. Fennel and its wide array of health benefits can be beneficial to lactating mothers.

Red raspberry is a plant native to Europe and parts of Asia and known for its sweet, nutritious berries. Red raspberry leaves provide B vitamins, vitamin C and many minerals, including potassium, magnesium, zinc, phosphorus and iron, however, their most notable contribution might be their antioxidant properties since they contain polyphenols like tannins and flavonoids, which act as antioxidants in your body and can help protect cells from damage. Additionally, the leaves contain small amounts of ellagic acids, which have been shown to neutralize carcinogens and even contribute to the self-destruction of cancer cells. Raspberry leaf is used for cardiovascular disorders, diarrhea, menstrual cramping (dysmenorrhea), gastrointestinal (GI) disorders, labor and delivery support, heavy menstrual periods (menorrhagia), miscarriage prevention, morning sickness, and respiratory disorders. Studies have showed that women who drank red raspberry leaf tea later in pregnancy had a reduction in the likelihood of pre- and post-term labor, and an 11% decreased use of forceps during birth for women who consumed red raspberry leaf tea in the last eight weeks of pregnancy. The American Pregnancy Association also states that drinking the tea may reduce the need for interventions during childbirth. Red raspberry leaves contain fragarine, a plant compound that helps tone and tighten muscles in the pelvic area, which may reduce the menstrual cramping caused by the spasms of these muscles and helps relieve other PMS symptoms like vomit, nausea and diarrhea.

Nutritional yeast is made from a single-celled organism called Saccharomyces cerevisiae. Nutritional yeast is grown on molasses then harvested, washed and heat-dried, which deactivates it. Nutritional yeast use dates back to the Egyptians. Nutritional yeast contains all nine essential amino acids that you must obtain from food. Nutritional yeast is also a source of high-quality plant protein. Fortified nutritional yeast is especially rich in B vitamins, including thiamine (B1), riboflavin (B2), niacin (B3), and B6 and B12 and in a variety of minerals, including zinc, selenium, manganese, and molybdenum, which are involved in gene regulation, metabolism, growth, and immunity. Studies show that nutritional yeast contains the powerful antioxidants glutathione and selenomethionine, which may help protect cells from damage caused by free radicals and heavy metals and help the body eliminate environmental toxins. Eating antioxidant-rich foods, like nutritional yeast, may also reduce the risk of chronic diseases like heart disease, cancer, macular degeneration. Nutritional yeast contains two main carbohydrates: alpha mannan and beta glucan. Animal studies suggest these carbs offer antibacterial and antifungal benefits, which may protect the body from infections. Yeast is especially rich in those vitamins necessary for lactating mothers, such as B12.

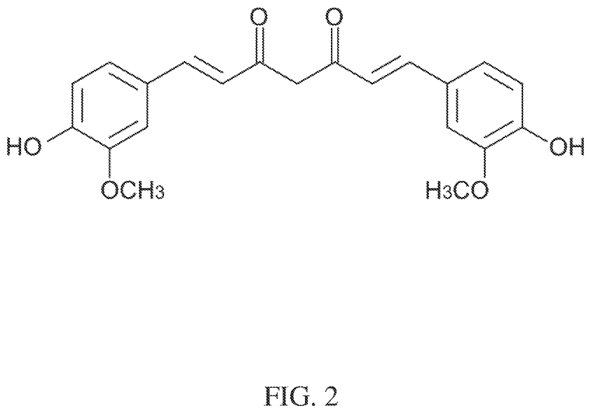

Turmeric is a spice that gives curry its yellow color. Turmeric comes from the root of Curcuma longa. Turmeric has been used in India for thousands of years as both a spice and medicinal herb. Recently, scientific studies have started to back up traditional claims that turmeric contains compounds with medicinal properties. These compounds are called curcuminoids and the most important one is curcumin (see FIG. 2), which is the main active ingredient in turmeric. Turmeric has powerful anti-inflammatory effects and is a very strong antioxidant. One tablespoon of turmeric contains: 26 percent of daily manganese needs, 16 percent of daily iron, 5 percent of daily potassium and 3 percent of daily vitamin C. Turmeric's medical properties have been proofed throughout different studies, wherein in one of them, patients with ulcerative colitis, took 2 grams of curcumin a day along with prescription medication and they were more likely to stay in remission than those who took the medicine alone. Another clinical trial showed that 90 milligrams of curcumin taken twice a day for 18 months helped improve memory performance in adults without dementia. Research also suggests that taking turmeric extract could potentially reduce pain from osteoarthritis. Turmeric has antioxidant properties, and one study shows that it may protect the body from free radicals by neutralizing them. A different study shows that curcumin was just as effective as fluoxetine in lessening symptoms of depression. Curcumin may also increase levels of serotonin and dopamine, which are the chemicals in the brain that regulate mood. These benefits are advantageous to lactating mothers.

Chromium is an essential mineral that the body needs in low amounts. Chromium is naturally present in a wide variety of foods in small amounts, and is also available as a supplement. Chromium enhances the action of the hormone insulin. Chromium is also involved in the breakdown and absorption of carbohydrate, proteins, and fats. Some of the best sources of chromium are broccoli, liver and brewer's yeast. Potatoes, whole grains, seafood, and meats also contain chromium. Some people use chromium supplements to control blood sugar with diabetes, provide relief from metabolic syndrome and polycystic ovary syndrome, control weight, and enhance muscle mass. Early studies suggested that supplemental chromium may contribute to weight loss and help increase muscle mass. In one study, 96 patients with type 2 diabetes took either 400 micrograms (mcg) a day of chromium picolinate, 200 mcg a day, or a placebo. Patients who took 400 mcg daily saw improvements in endothelial function, lipid profile, and biomarkers of oxidative stress, suggesting that chromium picolinate could benefit patients with type 2 diabetes. Chromium appears to play a role in carbohydrate, fat, and protein metabolism by boosting the effect of insulin. Due to its ability to assist in metabolism, chromium is advantageous for lactating mothers.

Zinc is a mineral that is essential for many of the body's normal functions and systems, including the immune system, wound healing, blood clotting, thyroid function, and the senses of taste and smell. Zinc also supports normal growth and development during pregnancy, childhood and adolescence. Zinc can naturally be found on the following foods: shellfish, meat, like, beef, pork lamb and bison, fish, such as flounder, sardines, salmon and sole, nuts and seeds like pumpkin seeds, cashews, hemp seeds, and on dairy products. Zinc helps the cells to grow and divide, and is necessary for the activity of enzymes, proteins and DNA. The body cannot make zinc so it must be obtained from food or supplements. Zinc is important for many of the body's functions. It helps strengthen the immune system, the body needs zinc to fight off infection. Zinc also supports the skin, and zin deficiency results in skin conditions such as eczema. Zinc may effectively reduce inflammation, boost immune health, reduce your risk of age-related diseases, speed wound healing and improve acne symptoms. Zinc is sold in some products to help with the common cold. Research shows that taking zinc lozenges or syrup can make cold symptoms less severe and last for less time, especially if you take them in the first 24 hours. Having enough zinc is especially important during pregnancy and for children to ensure they grow and develop properly. Due to its ability to assist in supporting normal growth and development, zinc is advantageous for lactating mothers.

Magnesium is a mineral found throughout the body. About 60% of the magnesium in the body occurs in bone, while the rest is in muscles, soft tissues, and fluids, including blood. Magnesium can be naturally found in pumpkin seeds, chia seeds, spinach, almonds, cooked black beans, cooked edamame, peanut butter, cooked brown rice, cooked salmon and avocado. One of magnesium's main roles is to act as helper molecule in the biochemical reactions performed by enzymes. Magnesium is involved in more than 600 reactions in your body, including energy creation, protein formation, gene maintenance, muscle movements and nervous system regulation. Studies show that magnesium supplements may be particularly beneficial for improving exercise performance in older adults and those with a deficiency in this nutrient. One study in 2,570 women associated higher magnesium intake with increased muscle mass and power. Studies also show that magnesium supplements can help lower high blood pressure levels, which may be a risk factor for heart disease. Another review linked high magnesium intake to a lower risk of heart disease, stroke, and high blood pressure. Due to its ability to support the biochemical reactions performed by enzymes, magnesium is advantageous for lactating mothers

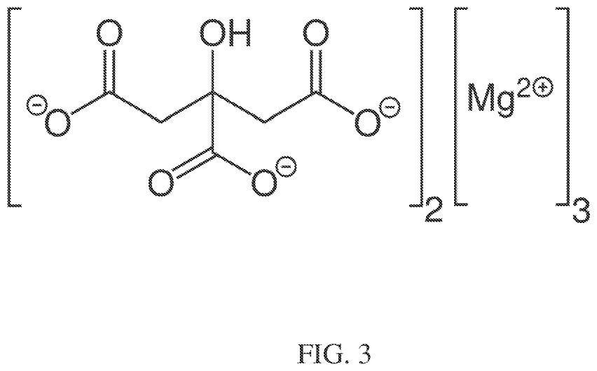

Magnesium citrate is a magnesium preparation in salt form with citric acid in a 1:1 ratio. Magnesium citrate (see FIG. 3) is used medicinally as a saline laxative and to completely empty the bowel prior to a major surgery or colonoscopy. It is available without a prescription, both as a generic and under various brand names. Magnesium citrate is also used in the pill form as a magnesium dietary supplement. Magnesium citrate contains 11.23% magnesium by weight. Compared to trimagnesium citrate, it is much more water-soluble, less alkaline, and contains less magnesium. As a food additive, magnesium citrate is used to regulate acidity. Magnesium citrate works by attracting water through the tissues by a process known as osmosis. Once in the intestine, it can attract enough water into the intestine to induce defecation. The additional water stimulates bowel motility. This means it can also be used to treat rectal and colon problems. Magnesium citrate solutions generally produce bowel movement in one half to three hours.

Cinnamon originates from a tree and the bark is used for gastrointestinal (GI) upset, diarrhea, and gas. It is also used for stimulating appetite, for infections caused by bacteria and parasitic worms, and for menstrual cramps, the common cold, and influenza. The oils found in cinnamon bark are thought to reduce spasms, reduce gas, and stimulate the appetite. Cinnamon might also increase blood flow. Cinnamon bark also contains a chemical that might work like insulin to lower blood sugar. There are also ingredients in cinnamon bark called tannins that might help wounds by acting as an astringent, and also prevent diarrhea. Cinnamon bark is associated with several important nutritional benefits. Cinnamon is a source of micronutrients such as vitamin K, iron, calcium, manganese and dietary fiber. A 1-tablespoon serving of cinnamon contains 1.4 milligrams of manganese, which is almost 75 percent of the recommended daily intake of 2 milligrams. Manganese may help prevent osteoporosis, anemia and symptoms of pre-menstrual syndrome. Many of cinnamon bark's nutritional and medicinal benefits relate to its potent antioxidant capacity. One study demonstrated that people that are overweight experienced less free radical damage while taking cinnamon supplements. By blocking the effects of free radicals, antioxidants such as cinnamon may help to prevent cardiovascular disease and certain forms of cancer. Patients with diabetes taking cinnamon experienced reductions in cholesterol and triglyceride levels, while those taking a placebo did not experience these effects. Due to its ability to stimulate appetites, cinnamon can be particularly helpful to lactating mothers.

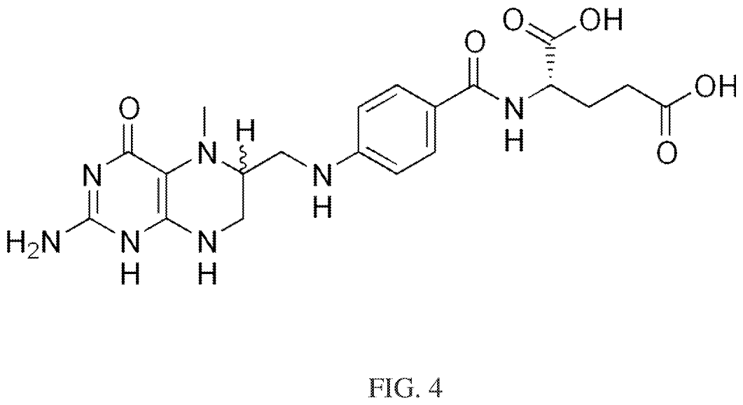

Methylfolate is the active form of vitamin B9 and can also be referred to as L-methylfolate. When taking folic acid, the body relies on methylenetetrahydrofolate reductase (MTHFR). This is both a gene and an enzyme that is found throughout the body. Methylfolate converts folic acid to its active form, L-methylfolate. This process is critical to the body having enough vitamin B. L-methylfolate helps produce serotonin, dopamine and norepinephrine. The production of these neurotransmitters aids with various issues like depression, Alzheimer's disease, anemia, and boosting the immune system. Methylfolate is also crucial in producing red blood cells. L-methylfolate (see FIG. 4) is the only form of folate that can cross the blood-brain barrier to help facilitate the synthesis of the neurotransmitters associated with mood regulation like serotonin, dopamine and norepinephrine. A deficiency in L-methylfolate has been linked to depression. Some food sources of L-methylfolate are sprouted legumes, spinach, romaine lettuce, cauliflower, asparagus, broccoli, kale, cabbage. Results of a study show that in a naturalistic setting, patients managed with L-methylfolate achieved statistically significant improvements in self-reported depression symptoms and functioning and greater satisfaction with their medication treatment. Due to its many health benefits, methylfolate can be particularly helpful to lactating mothers.

Vitamin B12 is an essential nutrient that helps the body create DNA, nourishes the brain and nervous system, and assists with the formation of healthy red blood cells. The nutrient occurs naturally in meat, fish, and dairy products, and can be created in a laboratory. Vitamin B12 plays a role in serotonin production, so a deficiency may be connected with clinical depression. In one study, disabled older women with a B12 deficiency were found to have double the risk of severe depression as those without a deficiency. Pregnant women with low B12 levels are also more likely to miscarry or give birth prematurely. Women with low levels of vitamin B12 are three times more likely to have a child with birth defects. In one randomized trial, older adults with early-stage dementia who were given vitamin B12 supplements to lower their blood homocysteine levels demonstrated a slower rate of cognitive and clinical decline. Another study found that low B12 levels, even within the normal range, contribute to poor memory performance.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A nutritional supplement composition of matter in powder form, the composition comprising of:
about 0.6 percent by weight of milk thistle powder;
about 0.06 percent by weight of fenugreek powder;
about 0.06 percent by weight of fennel seeds powder;
about 1.98 percent by weight of red raspberry leaf powder;
about 0.4 percent by weight of nutritional yeast;
about 0.06 percent by weight of turmeric;
about 0.003 percent by weight of chromium;
about 0.05 percent by weight of zinc;
about 0.7 percent by weight of magnesium;
about 1.3 percent by weight of cinnamon bark powder;
about 0.1 percent by weight of L-methylfolate; and
about 0.009 percent by weight of vitamin B12.

2. The nutritional supplement composition of matter of claim 1, further comprising:
about 18.5 percent by weight of pea protein powder;
about 27.76 percent by weight of organic brown rice protein powder;
about 12.78 percent by weight of organic pumpkin seed protein powder;
about 0.22 percent by weight of organic blueberry powder;
about 0.11 percent by weight of organic chia seed powder;
about 0.57 percent by weight of chlorella;
about 0.44 percent by weight of coconut milk powder;
about 0.11 percent by weight of flaxseed powder;
about 1.10 percent by weight of guar gum;
about 0.06 percent by weight of monk fruit powder;
about 0.22 percent by weight of raspberry ketones powder;
about 1.98 percent by weight of spirulina powder;
about 3.52 percent by weight of cinnamon powder;
about 1.76 percent by weight of spinach powder;
about 15.42 percent by weight of sugar powder;
about 0.99 percent by weight of stevia powder;
about 0.22 percent by weight of sweet enhancer powder;
about 0.66 percent by weight of natural vanilla flavor; and
about 0.66 percent by weight of xanthan gum.

3. An article for human consumption, the article comprising:
a container for holding a nutritional supplement composition of matter in powder form, the composition comprising of:
about 0.6 percent by weight of milk thistle powder;
about 0.06 percent by weight of fenugreek powder;
about 0.06 percent by weight of fennel seeds powder;
about 1.98 percent by weight of red raspberry leaf powder;
about 0.4 percent by weight of nutritional yeast;
about 0.06 percent by weight of turmeric;
about 0.003 percent by weight of chromium;
about 0.05 percent by weight of zinc;
about 0.7 percent by weight of magnesium;
about 1.3 percent by weight of cinnamon bark powder;
about 0.1 percent by weight of L-methylfolate; and
about 0.009 percent by weight of vitamin B12.

4. The article for human consumption of claim 3, the nutritional supplement composition of matter further comprising:
about 18.5 percent by weight of pea protein powder;
about 27.76 percent by weight of organic brown rice protein powder;
about 12.78 percent by weight of organic pumpkin seed protein powder;
about 0.22 percent by weight of organic blueberry powder;
about 0.11 percent by weight of organic chia seed powder;
about 0.57 percent by weight of chlorella;
about 0.44 percent by weight of coconut milk powder;
about 0.11 percent by weight of flaxseed powder;
about 1.10 percent by weight of guar gum;
about 0.06 percent by weight of monk fruit powder;
about 0.22 percent by weight of raspberry ketones powder;
about 1.98 percent by weight of spirulina powder;
about 3.52 percent by weight of cinnamon powder;
about 1.76 percent by weight of spinach powder;
about 15.42 percent by weight of sugar powder;
about 0.99 percent by weight of stevia powder;
about 0.22 percent by weight of sweet enhancer powder;
about 0.66 percent by weight of natural vanilla flavor; and
about 0.66 percent by weight of xanthan gum.
